(19) United States
(12) Patent Application Publication
(10) Pub. No.: US 2025/0125323 A1
(43) Pub. Date: Apr. 17, 2025

(54) METHODS OF MANUFACTURING POSITIVE ELECTRODE AND SOLID ELECTROLYTE COMPOSITE STRUCTURES FOR BATTERIES THAT CYCLE LITHIUM IONS

(71) Applicant: GM GLOBAL TECHNOLOGY OPERATIONS LLC, Detroit, MI (US)

(72) Inventors: Xiaosong HUANG, Novi, MI (US); Chaunlong WANG, Troy, MI (US); Shaomao XU, Sterling Heights, MI (US)

(21) Appl. No.: 18/488,318

(22) Filed: Oct. 17, 2023

(51) Int. Cl. H01M 10/058; H01M 4/02; H01M 4/04; H01M 4/1391; H01M 10/0562

(52) U.S. Cl. CPC H01M 4/04

(57) ABSTRACT

A method of manufacturing a composite structure for a battery that cycles lithium ions includes depositing a positive electrode precursor on a substrate to form a positive electrode layer, compacting the positive electrode layer, depositing a solid electrolyte precursor on the substrate over the positive electrode layer to form a solid electrolyte layer, compacting the solid electrolyte layer on the substrate over the positive electrode layer to form a composite structure, and heat treating the composite structure to sinter the solid electrolyte layer. The positive electrode precursor includes electroactive material particles, solid electrolyte particles, and electrically conductive particles. The solid electrolyte precursor includes solid electrolyte particles.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to solid electrolytes for batteries that cycle lithium ions, and more particularly to methods of manufacturing composite structures comprising a positive electrode and a solid electrolyte overlying the positive electrode.

Batteries that cycle lithium ions generally comprise a negative electrode, a positive electrode, and an electrolyte that provides a medium for the conduction of lithium ions between the negative and positive electrodes. The electrolyte may be in the form of a liquid, solid, or gel. In comparison to batteries comprising liquid electrolytes, solid-state batteries comprising solid electrolytes have higher energy densities, do not require the use of organic solvents, are not susceptible to swelling, and may inhibit the formation of lithium dendrites. The solid electrolytes may be formulated and manufactured to exhibit a desirable combination of features, including relatively small thicknesses to enable fast charging rates and high current densities, high uniformity and crack-free to ensure an even current density distribution and to prevent the formation of lithium dendrites, and the ability to establish and maintain good interfacial contact with surfaces of the electrodes to decrease interfacial resistance and ensure sufficient battery cycle life.

### SUMMARY

A method of manufacturing a composite structure for a battery that cycles lithium ions is disclosed. In the method, a positive electrode precursor is deposited on a substrate to form a positive electrode layer having a first end, an opposite second end, and a facing surface extending between the first end and the opposite second end. The positive electrode precursor comprises electroactive material particles, solid electrolyte particles, and electrically conductive particles. The positive electrode layer is compacted on the substrate. Then, a solid electrolyte precursor is deposited on the substrate over the positive electrode layer to form a solid electrolyte layer having a major facing surface. The solid electrolyte precursor comprises solid electrolyte particles. The solid electrolyte layer is compacted on the substrate over the positive electrode layer to form a composite structure including the positive electrode layer and the solid electrolyte layer. The composite structure is heat treated to sinter the solid electrolyte layer.

The positive electrode precursor may be prepared by mixing the electroactive material particles, the solid electrolyte particles, and the electrically conductive particles together in an extruder. In such case, the positive electrode precursor may be deposited on the substrate via extrusion.

The method may further comprise, prior to depositing the solid electrolyte precursor on the substrate over the positive electrode layer, applying a liquid electrolyte solution to the positive electrode layer to form a solid interphase layer on surfaces of the electroactive material particles.

The solid electrolyte precursor may be deposited on the substrate over the positive electrode layer via extrusion.

The positive electrode layer may be compacted by applying a force of greater than or equal to about 100 megapascals to the facing surface of the positive electrode layer.

The solid electrolyte layer may be compacted by applying a force of less than 100 megapascals to the major facing surface of the solid electrolyte layer.

Prior to compacting the positive electrode layer and the solid electrolyte layer, the positive electrode layer and the solid electrolyte layer each may have a porosity of greater than or equal to about 50% and less than or equal to about 70%. After compacting the positive electrode layer and the solid electrolyte layer, the positive electrode layer and the solid electrolyte layer each have a porosity of greater than or equal to about 20% and less than or equal to about 45%.

The solid electrolyte precursor may be deposited on the substrate over the positive electrode layer such that the solid electrolyte layer extends over an entire facing surface of the positive electrode layer and along the first end and the opposite second end of the positive electrode layer such that the positive electrode layer is entirely encapsulated on the substrate by the solid electrolyte layer.

After the composite structure is heat treated, the solid electrolyte layer may have a thickness extending over the facing surface of the positive electrode layer of greater than or equal to about 1 micrometer and less than or equal to about 30 micrometers.

The positive electrode precursor may further comprise an organic solvent. In such case, after the positive electrode precursor is deposited on the substrate, the organic solvent may be removed therefrom to form the positive electrode layer.

The solid electrolyte precursor may further comprises an organic solvent. In such case, after the solid electrolyte precursor is deposited on the substrate over the positive electrode layer, the organic solvent may be removed therefrom to form the solid electrolyte layer.

The composite structure may be heat treated at a temperature of greater than or equal to about 1000 degrees Celsius to sinter the solid electrolyte layer.

The substrate may comprise a release film. In such case, the method may further comprise, prior to heat treating the composite structure, removing the composite structure from the substrate and applying the composite structure to a major surface of a positive electrode current collector.

The composite structure may be manufactured using a continuous roll-to-roll process. In such case, the substrate may comprise a web extending between a supply roll and a take-up roll.

The positive electrode layer may be compacted by passing the positive electrode layer and the substrate between a first pair of calender rolls. The solid electrolyte layer may be compacted by passing the solid electrolyte layer and the substrate between a second pair of calender rolls.

The positive electrode layer may have a gradient structure. In such case, the method may further comprise depositing a first positive electrode precursor on the substrate to form a first positive electrode layer, and then depositing a second positive electrode precursor on the substrate over the first positive electrode layer to form a second positive electrode layer over the first positive electrode layer. The first positive electrode precursor and the second positive electrode precursor each may comprise the electroactive material particles, the solid electrolyte particles, and the electrically conductive particles. A concentration of the solid electrolyte particles in the first positive electrode precursor may be greater than that in the second positive electrode precursor, and a concentration of the electrically conductive particles in the second positive electrode precursor may be greater than that in the first positive electrode precursor.

The electroactive material particles may comprise a lithium transition metal oxide. The solid electrolyte particles may comprise an oxide-based solid electrolyte material, a sulfide-based solid electrolyte material, or a combination thereof.

A battery is disclosed comprising a composite structure manufactured by the method described herein.

A method of manufacturing a composite structure for a battery that cycles lithium ions is disclosed. In the method, a positive electrode precursor is deposited on a substrate to form a positive electrode layer. The positive electrode precursor comprises electroactive material particles, solid electrolyte particles, and electrically conductive particles. A solid electrolyte precursor is deposited on the substrate over the positive electrode layer to form a solid electrolyte layer over the positive electrode layer. The solid electrolyte precursor comprises solid electrolyte particles. The positive electrode precursor and the solid electrolyte precursor are deposited substantially simultaneously on the substrate by extrusion. The positive electrode layer and the solid electrolyte layer are compacted on the substrate to form a composite structure comprising the positive electrode layer and the solid electrolyte layer. The composite structure is transferred from the substrate to a positive electrode current collector and heat treated on the positive electrode current collector to sinter the solid electrolyte layer.

The substrate may comprise a polymer and the positive electrode current collector may comprise aluminum.

The solid electrolyte precursor may be deposited on the substrate over the positive electrode layer such that the positive electrode layer is entirely encapsulated on the substrate by the solid electrolyte layer.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a schematic perspective view of an automotive vehicle powered by a battery pack that includes multiple battery modules.

FIG. 2 is a schematic cross-sectional view of a portion of one of the battery modules of FIG. 1, the battery module including multiple electrochemical cells or batteries that cycle lithium ions.

FIG. 3 is a schematic cross-sectional view of a battery that cycles lithium ions, the battery comprising a positive electrode, a negative electrode, and a solid electrolyte disposed between the positive electrode and the negative electrode.

FIG. 4 is a schematic depiction of a step in a method of manufacturing the battery of FIG. 3, wherein the positive electrode is deposited on a substrate and compacted by applying a force to facing surface thereof, the positive electrode comprising electroactive material particles, solid electrolyte particles, and electrically conductive particles.

FIG. 5 is a schematic depiction of a step in a method of manufacturing the battery of FIG. 3, wherein a liquid electrolyte solution is applied to the positive electrode of FIG. 4 to form a solid interphase layer on surfaces of the electroactive material particles.

FIG. 6 is a schematic depiction of a step in a method of manufacturing the battery of FIG. 3, wherein a solid electrolyte is deposited on the substrate over the positive electrode of FIG. 5, and then the solid electrolyte is compacted to form a composite structure comprising the positive electrode and the solid electrolyte.

FIG. 7 is a schematic depiction of a step in a method of manufacturing the battery of FIG. 3, wherein the composite structure of FIG. 6 is applied to a major surface of a positive electrode current collector.

FIG. 8 is a schematic depiction of a method of manufacturing the battery of FIG. 3, wherein a continuous roll-to-roll technique is used to form a composite structure comprising the positive electrode and the solid electrolyte.

In the drawings, reference numbers may be reused to identify similar and/or identical elements.

### DETAILED DESCRIPTION

The presently disclosed methods can be used to form thin, wrinkle- and crack-free solid electrolytes for batteries that cycle lithium ions. In the disclosed methods, a composite structure is formed by depositing a positive electrode and a solid electrolyte on a substrate such that the solid electrolyte is deposited on the substrate and over the positive electrode. The solid electrolyte is compacted on the substrate over the positive electrode to form the composite structure. Then, the composite structure is heat treated to sinter the solid electrolyte. In aspects, prior to depositing the solid electrolyte on the substrate over the positive electrode, a liquid electrolyte solution may be applied to the positive electrode to form a solid interphase layer thereon, which may help prevent undesirable chemical reactions from occurring between the positive electrode and the solid electrolyte during subsequent manufacturing steps.

Forming the solid electrolyte on and over the positive electrode prior to compacting and sintering the solid electrolyte may help prevent the formation of wrinkles and cracks in the solid electrolyte, which may help prevent the formation of lithium dendrites. In addition, forming the solid electrolyte on and over the positive electrode prior to compacting and sintering the solid electrolyte may eliminate manufacturing challenges related to the brittle nature of certain solid electrolyte materials, which might otherwise occur if the solid electrolyte was compacted and sintered as a free-standing layer prior to being assembled along with the positive electrode in a battery.

FIG. 1 depicts an automotive vehicle 2 powered by an electric motor 4 that draws electricity from a battery pack 6 including one or more battery modules 8. The battery modules 8 may be electrically coupled together in a series and/or parallel arrangement to meet desired capacity and power requirements of the electric motor 4. The vehicle 2 may be an all-electric vehicle and may be powered exclusively by the electric motor 4, or the vehicle 2 may be a hybrid electric vehicle and may be powered by the electric motor 4 and by an internal combustion engine (not shown).

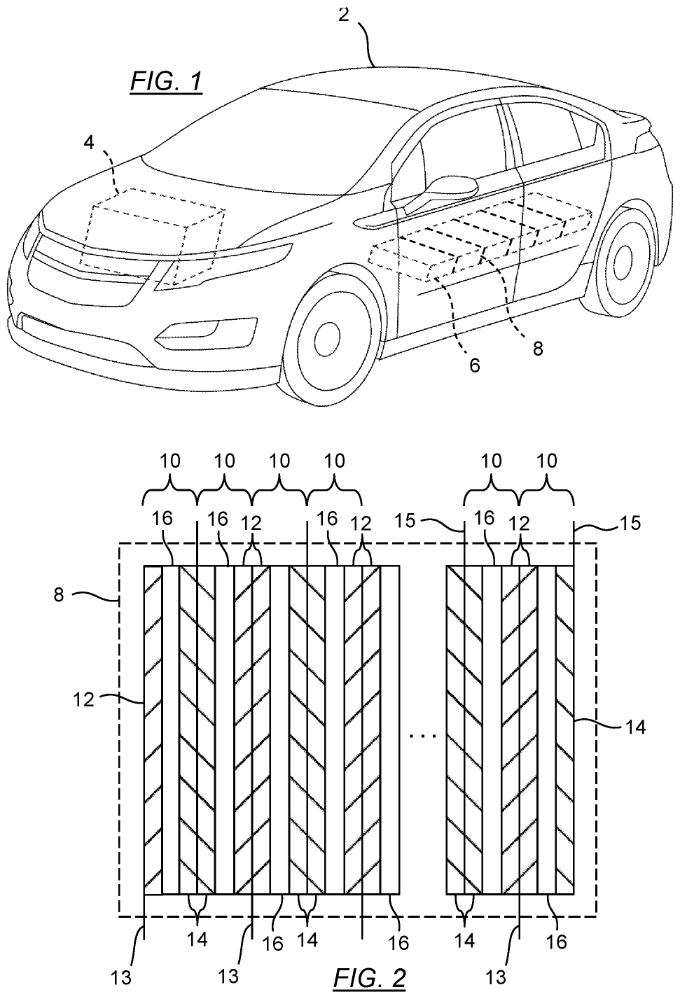

As shown in FIG. 2, each battery module 8 includes one or more electrochemical cells or batteries 10 that cycle lithium ions. In practice, the batteries 10 in the battery module 8 are oftentimes assembled as a stack of layers, including negative electrode layers 12, negative electrode current collectors 13, positive electrode layers 14, positive electrode current collectors 15, and separator layers 16. Each battery 10 is defined by a negative electrode layer 12 and a positive electrode layer 14, which are spaced apart from each other by a separator layer 16. In practice, the separator layer 16 may be infiltrated with an electrolyte that provides a medium for the conduction of lithium ions between the negative electrode layer 12 and the positive electrode layer 14, or the separator layer 16 itself may be formulated to function as an electrolyte. The negative electrode layers 12 are disposed on and in electrical communication with the negative electrode current collectors 13 and the positive electrode layers 14 are disposed on an in electrical communication with the positive electrode current collectors 15. As shown in FIG. 2, for efficiency, the layers may be stacked such that some of the negative electrode current collectors 13 and some of the positive electrode current collectors 15 are double sided and respectively include negative electrode layers 12 or positive electrode layers 14 on both sides thereof. In this arrangement, adjacent negative electrode layers 12 and positive electrode layers 14 respectively share a single negative electrode current collector 13 or a positive electrode current collector 15.

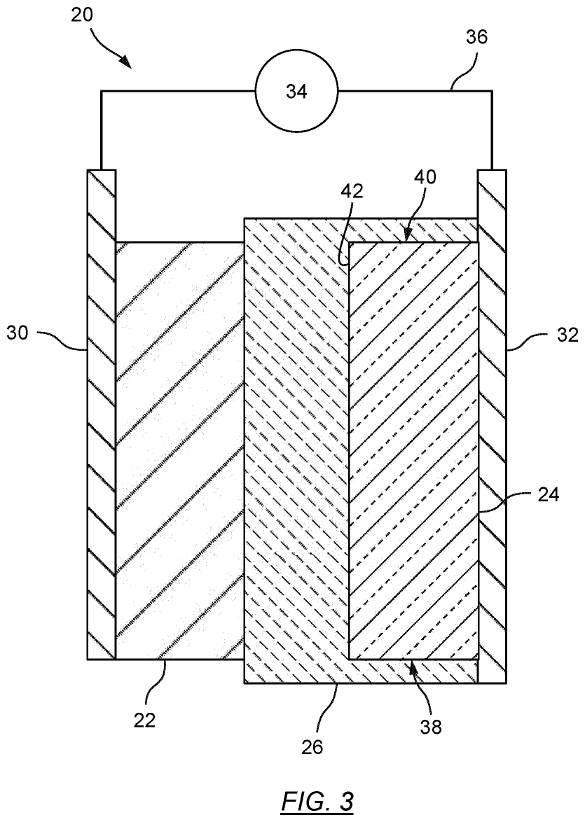

FIG. 3 depicts an electrochemical cell or battery 20 that cycles lithium ions. The battery 20 can generate an electric current during discharge, which may be used to supply power to a load device (e.g., an electric motor 4), and can be charged by being connected to a power source. Like the batteries 10 depicted in FIGS. 1 and 2, the battery 20 may be used to supply power to an electric motor 4 of an automotive vehicle 2. Additionally or alternatively, the battery 20 may be used in other transportation applications (e.g., motorcycles, boats, tractors, buses, motorcycles, mobile homes, campers, tanks, and aircraft), and may be used to provide electricity to stationary and/or portable electronic equipment, components, and devices used in a wide variety of other industries and applications, including industrial, residential, and commercial buildings, consumer products, industrial equipment and machinery, agricultural or farm equipment, and heavy machinery, by way of nonlimiting example.

The battery 20 comprises a negative electrode 22, a positive electrode 24, and a solid electrolyte 26 at least partially disposed between the negative electrode 22 and the positive electrode 24. The negative electrode 22 is disposed on a negative electrode current collector 30 and the positive electrode 24 is disposed on a positive electrode current collector 32. The positive electrode 24 has a first end 38, an opposite second end 40, and a facing surface 42 that extends between the first end 38 and the opposite second end 40 and faces toward the negative electrode 22.

In practice, the negative electrode current collector 30 and the positive electrode current collector 32 are electrically coupled to a power source or load 34 (e.g., the electric motor 4) via an external circuit 36. The negative electrode 22 and the positive electrode 24 are formulated such that, when the battery 20 is at least partially charged, an electrochemical potential difference is established between the negative electrode 22 and the positive electrode 24. During discharge of the battery 20, the electrochemical potential established between the negative electrode 22 and the positive electrode 24 drives spontaneous reduction and oxidation (redox) reactions within the battery 20 and the release of lithium ions and electrons at the negative electrode 22. The released lithium ions travel from the negative electrode 22 to the positive electrode 24 through the solid electrolyte 26, while the electrons travel from the negative electrode 22 to the positive electrode 24 via the external circuit 36, which generates an electric current. After the negative electrode 22 has been partially or fully depleted of lithium, the battery 20 may be charged by connecting the negative electrode 22 and the positive electrode 24 to the power source 34, which drives nonspontaneous redox reactions within the battery 20 and the release of the lithium ions and the electrons from the positive electrode 24. The repeated discharge and charge of the battery 20 may be referred to herein as “cycling,” with a full charge event followed by a full discharge event being considered a full cycle.

The solid electrolyte 26 extends between the negative electrode 22 and the positive electrode 24 and provides a medium for the conduction of lithium ions through the battery 20 between the negative electrode 22 and the positive electrode 24. In addition, the solid electrolyte 26 physically separates and electrically isolates the negative electrode 22 and the positive electrode 24 from each other while permitting lithium ions to pass therethrough. As shown in FIG. 3, the solid electrolyte 26 may extend over the entire facing surface 42 of the positive electrode 24 and may extend from the facing surface 42 of the positive electrode 24 along the first end 38 and the opposite second end 40 of the positive electrode 24 such that the positive electrode 24 is entirely encapsulated by the solid electrolyte 26. The solid electrolyte 26 may have a width defined between the negative electrode 22 and the positive electrode 24 of greater than or equal to about 0.5 micrometers (μm), or optionally greater than or equal to about 10 μm and less than or equal to about 50 μm, or optionally less than or equal to about 30 μm.

As best shown in FIG. 7, the solid electrolyte 26 comprises ionically conductive solid electrolyte particles 44 and optionally one or more additives (not shown). The solid electrolyte particles 44 may have a mean particle diameter of greater than or equal to about 0.1 μm and less than or equal to about 20 μm.

The solid electrolyte particles 44 comprise an ionically conductive solid electrolyte material. For example, the solid electrolyte particles 44 may comprise an inorganic solid electrolyte material, a solid polymer electrolyte material, or a combination thereof. Examples of inorganic solid electrolyte materials include oxide-based solid electrolyte materials and sulfide-based solid electrolyte materials. Examples of oxide-based solid electrolyte materials include NASICON-type solid electrolyte materials (e.g., Li_{1.4}Al_{0.4}Ti_{1.6}(PO₄)₃), LISICON-type solid electrolyte materials (e.g., Li₂₊₂ₓZn₁₋ₓGeO₄), perovskite-type solid electrolyte materials (e.g., Li₃ₓLa_{2/3-x}TiO₃), garnet-type solid electrolyte materials (e.g., Li₇La₃Zr₂O₁₂), and/or metal-doped or aliovalent-substituted metal oxide-based solid electrolyte materials (e.g., Al- or Nb-doped Li₇La₃Zr₂O₁₂, Sb-doped Li₇La₃Zr₂O₁₂, Ga-substituted Li₇La₃Zr₂O₁₂, Cr and V-substituted LiSn₂P₃O₁₂, and/or Al-substituted perovskite, Li_{1+x+y}AlₓTi₂₋ₓSi_{y}P_{3-y}O₁₂.). Examples of sulfide-based solid electrolyte materials include argyrodite materials represented by the formula Li₆PS₅X, where X═Cl, Br, I; lithium phosphorus sulfide materials represented by one or more of the following formulas Li₃PS₄, Li_{9.6}P₃S₁₂, and/or Li₇P₃S₁₁; LGPS-type materials represented by the formula Li₁₁₋ₓM₂₋ₓP₁₊ₓS₁₂, where M=Ge, Sn, Si (e.g., Li₁₀GeP₂S₁₂, Li₉P₃S₉O₃, Li_{10.35}Ge_{1.35}P_{1.65}S₁₂, Li_{10.35}Si_{1.35}P_{1.65}S₁₂, Li_{9.81}Sn_{0.81}P_{2.19}S₁₂, Li₁₀(Si_{0.5}Ge_{0.5})P₂S₁₂, Li₁₀(Ge_{0.5}Sn_{0.5})P₂S₁₂, and/or Li₁₀(Si_{0.5}Sn_{0.5})P₂S₁₂); Li₂S—P₂S₅-type materials; Li₂S—P₂S₅-MOx-type materials; Li₂S—P₂S₅-MSx-type materials; thio-LISICON-type materials (e.g., Li_{3.25}Ge_{0.25}P_{0.75}S₄); Li_{3.4}Si_{0.4}P_{0.6}S₄; Li₁₀GeP₂S_{11.7}O_{0.3}; Li_{9.54}Si_{1.74}P_{1.44}S_{11.7}Cl_{0.3}; Li_{3.833}Sn_{0.833}As_{0.166}S₄; LiI—Li₄SnS₄; and/or Li₄SnS₄. Examples of solid polymer electrolyte materials include polyethylene oxide (PEO), polyacrylonitrile (PAN), polymethyl methacrylate (PMMA), polyvinylidene fluoride (PVDF), and combinations thereof.

The positive electrode 24 is formulated to reversibly store and release lithium ions during discharge and charge of the battery 20 and is in the form of a continuous porous layer disposed on a major surface of the positive electrode current collector 32. As best shown in FIG. 7, the positive electrode 24 comprises electrochemically active (electroactive) material particles 46, solid electrolyte particles 44, electrically conductive particles 48, and optionally a polymer binder (not shown).

The electroactive material particles 46 are uniformly distributed throughout the positive electrode 24 and comprise an electroactive material that can store and release lithium ions by undergoing a reversible redox reaction with lithium at a higher electrochemical potential than the electroactive material of the negative electrode 22 such that an electrochemical potential difference exists between the negative electrode 22 and the positive electrode 24. For example, the electroactive material particles 46 may comprise a material that can undergo lithium intercalation and deintercalation or a material that can undergo a conversion reaction with lithium. In aspects where the electroactive material particles 46 comprise an intercalation host material that can undergo the reversible insertion or intercalation of lithium ions, the electroactive material particles 46 may comprise a lithium transition metal oxide. For example, the electroactive material particles 46 may comprise a layered lithium transition metal oxide represented by the formula LiMeO₂, an olivine-type lithium transition metal oxide represented by the formula LiMePO₄, a monoclinic-type lithium transition metal oxide represented by the formula Li₃Me₂(PO₄)₃, a spinel-type lithium transition metal oxide represented by the formula LiMe₂O₄, a tavorite represented by one or both of the following formulas LiMeSO₄F or LiMePO₄F, or a combination thereof, where Me is a transition metal (e.g., Co, Ni, Mn, Fe, Al, V, or a combination thereof). In aspects where the electroactive material particles 46 comprise a conversion material, the electroactive material particles 46 may comprise sulfur, selenium, tellurium, iodine, a halide (e.g., a fluoride or chloride), sulfide, selenide, telluride, iodide, phosphide, nitride, oxide, oxysulfide, oxyfluoride, sulfur-fluoride, sulfur-oxyfluoride, or a lithium and/or metal compound thereof (e.g., a compound of iron, manganese, nickel, copper, and/or cobalt). The electroactive material particles 46 may constitute, by weight, greater than or equal to about 50%, optionally greater than or equal to about 60%, or optionally greater than or equal to about 70% and less than or equal to about 95%, optionally less than or equal to about 90%, or optionally less than or equal to about 80% of the positive electrode 24.

In aspects, a solid interphase layer 52 may be disposed on and over an exterior surface of each of the electroactive material particles 46. The solid interphase layer 52 may comprise an electrically insulating and ionically conductive material and may be formulated to prevent undesirable chemical reactions from occurring between the electroactive material particles 46 in the positive electrode 24 and the solid electrolyte particles 44 in the solid electrolyte 26.

The solid interphase layer 52 may comprise the decomposition products of a liquid electrolyte solution. The optional solid interphase layer 52 may be formed on the exterior surface of each of the electroactive material particles 46 after formation of the positive electrode 24 and prior to assembly of the battery 20.

The solid electrolyte particles 44 included in the positive electrode 24 may comprise one or more of the ionically conductive solid electrolyte materials disclosed above with respect to the solid electrolyte 26. The solid electrolyte particles 44 included in the positive electrode 24 may have the same composition or a different composition than that of the solid electrolyte particles 44 included in the solid electrolyte 26. The solid electrolyte particles 44 may constitute, by weight, greater than 0%, optionally greater than or equal to about 10%, or optionally greater than or equal to about 15% and less than or equal to about 30%, or optionally less than or equal to about 20% of the positive electrode 24.

The electrically conductive particles 48 are electrochemically inactive and are included in the positive electrode 24 to provide the positive electrode 24 with sufficient electrical conductivity to support the percolation of electrons therethrough. The electrically conductive particles 48 comprise an electrically conductive material. Examples of electrically conductive materials include carbon-based materials, metals (e.g., nickel), and/or electrically conductive polymers. Examples of electrically conductive carbon-based materials include carbon black (CB) (e.g., acetylene black), graphite, graphene (e.g., graphene nanoplatelets, GNP), graphene oxide, carbon nanotubes (CNT), and/or carbon fibers (e.g., carbon nanofibers). Examples of electrically conductive polymers include polyaniline, polythiophene, polyacetylene, and/or polypyrrole. The electrically conductive particles 48 may constitute, by weight, greater than 0%, optionally greater than or equal to about 1%, or optionally greater than or equal to about 5% and less than or equal to about 10% of the positive electrode 24.

The optional polymer binder is electrochemically inactive and may be included in the positive electrode 24 to provide the positive electrode 24 with structural integrity and/or to help the positive electrode 24 adhere to the major surface of the positive electrode current collector 32. Examples of polymer binders include polyvinylidene fluoride (PVdF), polytetrafluoroethylene (PTFE), ethylene propylene diene monomer (EPDM) rubber, styrene butadiene rubber (SBR), carboxymethyl cellulose (CMC), nitrile butadiene rubber (NBR), styrene-butadiene rubber (SBR), styrene ethylene butylene styrene copolymer (SEBS), polyacrylates, alginates, polyacrylic acid, and combinations thereof. When present, the polymer binder may constitute, by weight, greater than or equal to about 1%, or optionally greater than or equal to about 5%, and less than or equal to about 10% of the positive electrode 24.

In aspects, the positive electrode 24 may have a gradient structure (not shown), with a proximal region of the positive electrode 24 being proximal to and extending along the major surface of the positive electrode current collector 32 and a distal region of the positive electrode 24 extending over the proximal region along the facing surface 42 of the positive electrode 24. In such case, the composition of the proximal region of the positive electrode 24 may be different from that of the distal region of the positive electrode 24. For example, the concentration of the solid electrolyte particles 44 in the proximal region of the positive electrode 24 may be greater than the concentration of the solid electrolyte particles 44 in the distal region of the positive electrode 24. Additionally or alternatively, the concentration of the electrically conductive particles 48 in the distal region of the positive electrode 24 may be greater than the concentration of the electrically conductive particles 48 in the proximal region of the positive electrode 24.

The negative electrode 22 is configured to store and release lithium ions during charge and discharge of the battery 20 and may be in the form of a continuous layer of material disposed on a major surface of the negative electrode current collector 30. The negative electrode 22 comprises an electrochemically active (electroactive) material (electroactive negative electrode material) that can store and release lithium ions by undergoing a reversible redox reaction with lithium during charge and discharge of the battery 20. Examples of electroactive materials for the negative electrode 22 include lithium, lithium-based materials, lithium alloys (e.g., alloys of lithium and silicon, aluminum, indium, tin, or a combination thereof), carbon-based materials (e.g., graphite, activated carbon, carbon black, hard carbon, soft carbon, and/or graphene), silicon, silicon-based materials (e.g., silicon oxide, alloys if silicon and tin, iron, aluminum, cobalt, or a combination thereof and/or composites of silicon and/or silicon oxide and carbon), tin oxide, aluminum, indium, zinc, germanium, silicon oxide, lithium silicon oxide, lithium silicide, titanium oxide, lithium titanate, and combinations thereof. The electroactive material of the negative electrode 22 may constitute, by weight, greater than or equal to about 50%, optionally greater than or equal to about 60%, or optionally greater than or equal to about 70% and less than or equal to about 95%, optionally less than or equal to about 90%, or optionally less than or equal to about 80% of the negative electrode 22.

In aspects, the electroactive material of the negative electrode 22 may consist of lithium and the negative electrode 22 may be in the form of a nonporous metal film or foil, such as a lithium metal film or lithium metal foil. In other aspects, the negative electrode 22 may be porous and the electroactive material of the negative electrode 22 may be a particulate material. In aspects where the electroactive material of the negative electrode 22 is a particulate material, particles of the electroactive material of the negative electrode 22 may be intermingled with particles of a solid electrolyte material, a polymer binder, and optionally an electrically conductive material. The same solid electrolyte materials, polymer binders, and/or electrically conductive materials disclosed above with respect to the positive electrode 24 may be used in the negative electrode 22 in substantially the same amounts.

The negative and positive electrode current collectors 30, 32 are electrically conductive and provide an electrical connection between the external circuit 36 and their respective negative and positive electrodes 22, 24. In aspects, the negative and positive electrode current collectors 30, 32 may be in the form of nonporous metal foils, perforated metal foils, porous metal meshes, or a combination thereof. The negative electrode current collector 30 may be made of copper, nickel, or alloys thereof, stainless steel, or other appropriate electrically conductive material. The positive electrode current collector 32 may be made of aluminum (Al) or another appropriate electrically conductive material.

### Methods

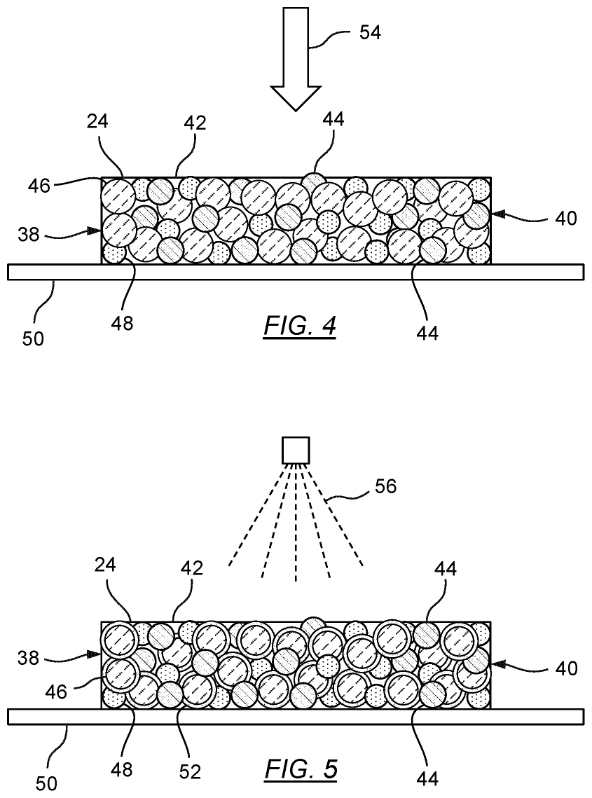

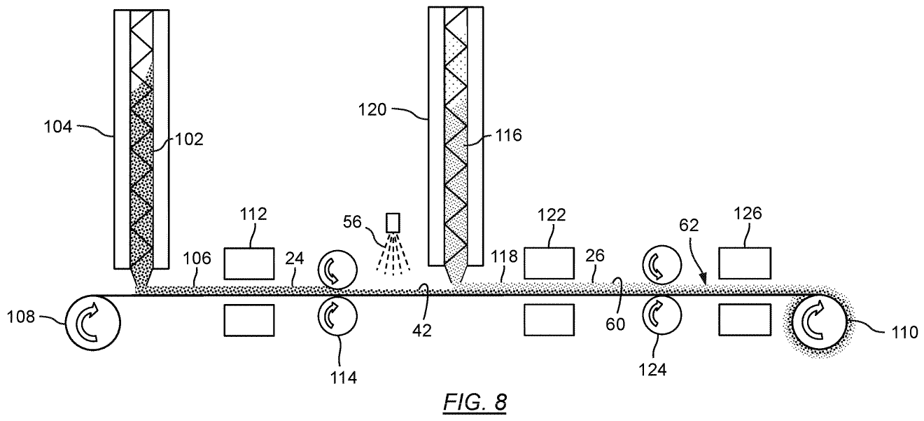

Referring now to FIGS. 4, 5, 6, 7, and 8, the positive electrode 24 and the solid electrolyte 26 may be manufactured by a method that includes one or more of the following steps. In aspects, the method may be performed as a batch process. In other aspects, the method may be performed as a continuous roll-to-roll process, as shown in FIG. 8.

A positive electrode precursor 102 is prepared comprising the electroactive material particles 46, the solid electrolyte particles 44, the electrically conductive particles 48, and the optional polymer binder in an organic solvent. The organic solvent may comprise a polar aprotic organic solvent, e.g., acetonitrile, tetrahydrofuran, or a combination thereof. In aspects, the positive electrode precursor 102 may be prepared by mixing the electroactive material particles 46, the solid electrolyte particles 44, the electrically conductive particles 48, the optional polymer binder, and the organic solvent together in a first extruder 104, as shown in FIG. 8.

The positive electrode precursor 102 is deposited on a substrate 50 to form a positive electrode precursor layer 106. In aspects, the substrate 50 may comprise a free-standing release film, which may comprise a polymer. In other aspects, the substrate 50 may comprise the positive electrode current collector 32 or may be made of the same material and have the same thickness as that of the positive electrode current collector 32. In any embodiment, the substrate 50 may be in the form of a continuous web extending between a supply roll 108 and a take-up roll 110. As shown in FIG. 8, in aspects, the positive electrode precursor 102 may be deposited on the substrate 50 by being extruded from the first extruder 104.

After the positive electrode precursor layer 106 is deposited on the substrate 50, the organic solvent is removed therefrom (e.g., by evaporation) to form the positive electrode 24 on the substrate 50, as shown in FIGS. 4 and 8. The organic solvent may be removed from the positive electrode precursor layer 106 by heating the positive electrode precursor layer 106 at a temperature less than or equal to about 200° C., or optionally less than or equal to about 100° C. As shown in FIG. 8, in aspects, the organic solvent may be removed from the positive electrode precursor layer 106 by passing the positive electrode precursor layer 106 through a heater 112.

In aspects where the positive electrode 24 has a gradient structure, the positive electrode 24 may be formed by preparing a first positive electrode precursor and second positive electrode precursor (not shown). A concentration of the solid electrolyte particles 44 in the first positive electrode precursor may be greater than that in the second positive electrode precursor and a concentration of the electrically conductive particles 48 in the second positive electrode precursor may be greater than that in the first positive electrode precursor. The first positive electrode precursor may be deposited on the substrate 50 to form a first positive electrode layer, and then the second positive electrode precursor may be deposited on the substrate 50 over the first positive electrode layer to form a second positive electrode layer over the first positive electrode layer.

The positive electrode 24 is compacted on the substrate 50 to reduce the porosity thereof. As shown in FIG. 4, the positive electrode 24 may be compacted by applying a force 54 to the facing surface 42 of the positive electrode 24. The force 54 applied to the facing surface 42 of the positive electrode 24 may be greater than or equal to about 100 megapascals (Mpa). The positive electrode 24 may be compacted at a temperature less than or equal to about 200° C., or optionally less than or equal to about 100° C. In aspects, the positive electrode 24 may be compacted at ambient temperature (e.g., 25° C.). In aspects, the force 54 may be applied to the facing surface 42 of the positive electrode 24 using a uniaxial pressing technique. In other aspects, the force 54 may be applied to the facing surface 42 of the positive electrode 24 using a calendaring process, wherein the positive electrode 24 is passed between a pair of calender rolls 114, as shown in FIG. 8. Prior to compacting the positive electrode 24, the positive electrode 24 may have a porosity of greater than or equal to about 50% and less than or equal to about 70%. After compacting the positive electrode 24, the positive electrode 24 may have a porosity of greater than or equal to about 20% and less than or equal to about 45%.

As shown in FIGS. 5 and 8, in aspects, a liquid electrolyte solution 56 may be applied to the positive electrode 24 to form the solid interphase layer 52 on and over the exterior surfaces of the electroactive material particles 46. The liquid electrolyte solution 56 may comprise a fluorinated lithium salt dissolved in an organic solvent and/or an ionic liquid. Examples of fluorinated lithium salts include lithium hexafluorophosphate (LiPF₆), lithium difluorophosphate (LiPO₂F₂), lithium tetrafluoroborate (LiBF₄), lithium hexafluoroarsenate (LiAsF₆), lithium trifluoromethanesulfonate (LiCF₃SO₃), lithium bis(trifluoromethane)sulfonylimide (LiN(CF₃SO₂)₂), lithium bis(fluorosulfonyl)imide (LiN(FSO₂)₂) (LiSFI), lithium difluoro (oxalato) borate (LiBF₂(C₂O₄)) (LIDFOB), and combinations thereof. The organic solvent may comprise a nonaqueous aprotic organic solvent. Non-limiting examples of non-aqueous aprotic organic solvents include cyclic carbonates (e.g., ethylene carbonate (EC), propylene carbonate (PC), butylene carbonate (BC), fluoroethylene carbonate (FEC), and vinylene carbonate (VC)); linear carbonates (e.g., dimethyl carbonate (DMC), diethyl carbonate (DEC), ethyl methyl carbonate (EMC)); aliphatic carboxylic esters (e.g., methyl formate, methyl acetate, methyl propionate); lactones (e.g., γ-butyrolactone, γ-valerolactone, and/or δ-valerolactone); nitriles (e.g., succinonitrile, glutaronitrile, and/or adiponitrile); sulfones (e.g., tetramethylene sulfone, ethyl methyl sulfone, vinyl sulfone, phenyl sulfone, 4-fluorophenyl sulfone, benzyl sulfone, and/or sulfolane); aliphatic ethers (e.g., triethylene glycol dimethyl ether, tetraethylene glycol dimethyl ether, 1,3-dimethoxypropane, 1,2-dimethoxyethane, 1-2-diethoxyethane, and/or ethoxymethoxyethane); cyclic ethers (e.g., 1,4-dioxane, tetrahydrofuran, 2-methyltetrahydrofuran), 1,3-dioxolane); phosphates (e.g., triethyl phosphate and/or trimethyl phosphate); and combinations thereof.

An electrolyte precursor 116 is prepared comprising the solid electrolyte particles 44 and optional additives in an organic solvent. The organic solvent used to prepare the electrolyte precursor may comprise a polar aprotic organic solvent, e.g., acetonitrile, tetrahydrofuran, or a combination thereof. The electrolyte precursor 116 is deposited on the substrate 50 over the positive electrode 24 to form an electrolyte precursor layer 118. In aspects, the electrolyte precursor 116 may be prepared by mixing the solid electrolyte particles 44, the optional additives, and the organic solvent together in a second extruder 120, and then extruding the electrolyte precursor 116 onto the substrate 50 over the positive electrode 24, as shown in FIG. 8.

The electrolyte precursor 116 may be deposited on the substrate 50 such that the electrolyte precursor layer 118 extends over the entire facing surface 42 of the positive electrode 24, from the first end 38 to the opposite second end 40 of the positive electrode 24. In addition, the electrolyte precursor layer 118 may extend from the facing surface 42 of the positive electrode 24 along the first end 38 and along the opposite second end 40 of the positive electrode 24. In other words, the electrolyte precursor 116 may be deposited on the substrate 50 over the positive electrode 24 such that the positive electrode 24 is entirely encapsulated by the electrolyte precursor layer 118.

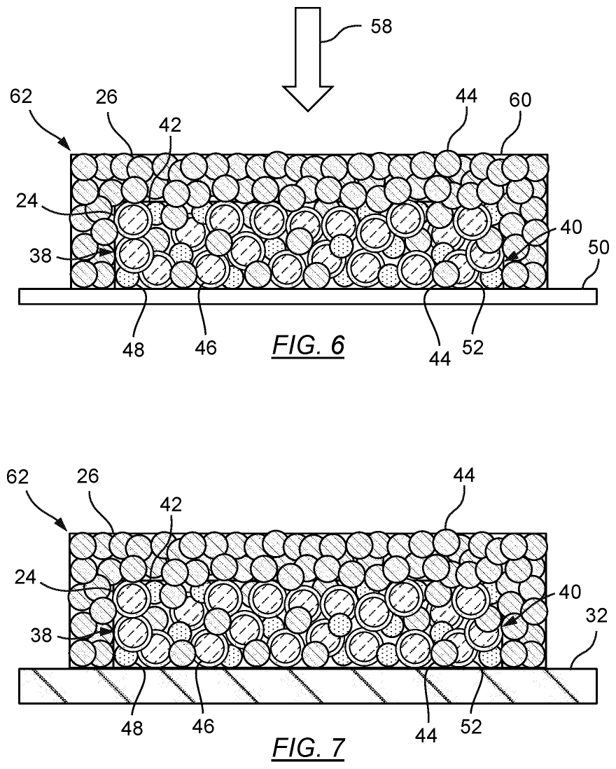

Then, the organic solvent is removed from the electrolyte precursor layer 118 (e.g., by evaporation) to form the solid electrolyte 26 on the substrate 50 over the positive electrode 24, as shown in FIGS. 6 and 8. The organic solvent may be removed from the electrolyte precursor layer 118 by heating the electrolyte precursor layer 118 at a temperature less than or equal to about 200° C., or optionally less than or equal to about 100° C. As shown in FIG. 8, in some aspects, the organic solvent may be removed from the electrolyte precursor layer 118 by passing the electrolyte precursor layer 118 through a heater 122. Like the electrolyte precursor 116, the solid electrolyte 26 may extend over the entire facing surface 42 of the positive electrode 24, from the first end 38 to the opposite second end 40 of the positive electrode 24. In addition, the solid electrolyte 26 may extend from the facing surface 42 of the positive electrode 24 along the first end 38 and along the opposite second end 40 of the positive electrode 24 such that the positive electrode 24 is entirely encapsulated by the solid electrolyte 26.

The solid electrolyte 26 is compacted on the substrate 50 over the positive electrode 24 to reduce the porosity thereof, for example, by applying a force 58 to a facing surface 60 of the solid electrolyte 26, as shown in FIG. 6. The solid electrolyte 26 may be compacted at a temperature of greater than or equal to about 100° C., or optionally greater than or equal to about 200° C. The force 58 applied to the facing surface 60 of the solid electrolyte 26 may be less than about 100 megapascals (Mpa). In aspects, the force 58 may be applied to the facing surface 60 of the solid electrolyte 26 using a uniaxial pressing technique. In other aspects, the force 58 may be applied to the facing surface 60 of the solid electrolyte 26 using a calendaring process, wherein the solid electrolyte 26 is passed between a pair of calender rolls 124, as shown in FIG. 8. Prior to compacting the solid electrolyte 26, the solid electrolyte 26 may have a porosity of greater than or equal to about 50% and less than or equal to about 70%. After compacting the solid electrolyte 26, the solid electrolyte 26 may have a porosity of greater than or equal to about 20% and less than or equal to about 45%.

Together, the compacted positive electrode 24 and the compacted solid electrolyte 26 define a composite structure 62.

In embodiments where the substrate 50 comprises a release film, after formation of the composite structure 62, the composite structure 62 including the positive electrode 24 and the solid electrolyte 26 may be removed from the substrate 50 and applied to a major surface of the positive electrode current collector 32, as shown in FIG. 7. The composite structure 62 may be applied to a major surface of the positive electrode current collector 32, for example, by lamination.

The composite structure 62 may be heat treated to sinter the positive electrode 24 and/or the solid electrolyte 26. In aspects, the composite structure 62 may be heat treated by passing the composite structure 62 through a heater 126, as shown in FIG. 8. In aspects, the composite structure 62 may be heat treated while the composite structure 62 is disposed on a major surface of the positive electrode current collector 32. The composite structure 62 may be heat treated, for example, by heating the composite structure 62 at a temperature of greater than or equal to about 400 degrees Celsius (° C.), optionally greater than or equal to about 500° C., optionally greater than or equal to about 800° C., optionally greater than or equal to about 1000° C., optionally greater than or equal to about 1200° C., or optionally greater than or equal to about 1500° C.

Without intending to be bound by theory, it is believed that forming the solid electrolyte 26 on and over the positive electrode 24 prior to heat treating the solid electrolyte 26 may allow for the formation of a solid electrolyte 26 that is wrinkle- and crack-free, which may help prevent the formation of lithium dendrites that might otherwise form on the negative electrode 22 and penetrate into the solid electrolyte 26 during cycling of the battery 20. In addition, it is believed that forming the solid electrolyte 26 on and over the positive electrode 24 prior to heat treating the solid electrolyte 26 may allow for the formation of a solid electrolyte 26 that is relatively thin, as compared to free-standing solid electrolyte layers that are formed and heat treated prior to being applied to surfaces of negative or positive electrodes.

After the composite structure 62 is heat treated, the composite structure 62 and the positive electrode current collector 32 may be assembled into the battery 20.

In aspects where the composite structure 62 is manufactured using a continuous roll-to-roll process, after the composite structure 62 is heat treated, the composite structure 62 and the substrate 50 may be wound onto the take-up roll 110, as shown in FIG. 8. Thereafter, portions of the composite structure 62 may be cut from the take-up roll and assembled into the battery 20.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

The terminology used herein is for the purpose of describing example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended terms “comprises,” “comprising,” “including,” and “having,” are to be understood as non-restrictive terms used to describe and claim various embodiments set forth herein, in certain aspects, the terms may alternatively be understood to instead be a more limiting and restrictive term, such as “consisting of” or “consisting essentially of.” Thus, for any given embodiment reciting compositions, materials, components, elements, ingredients, features, integers, operations, and/or process steps, the present disclosure also specifically includes embodiments consisting of, or consisting essentially of, such recited compositions, materials, components, elements, ingredients, features, integers, operations, and/or process steps. In the case of “consisting of,” the alternative embodiment excludes any additional compositions, materials, components, elements, ingredients, features, integers, operations, and/or process steps, while in the case of “consisting essentially of,” any additional compositions, materials, components, elements, ingredients, features, integers, operations, and/or process steps that materially affect the basic and novel characteristics are excluded from such an embodiment, but any compositions, materials, components, elements, ingredients, features, integers, operations, and/or process steps that do not materially affect the basic and novel characteristics can be included in the embodiment.

Any method steps, processes, and operations described herein are not to be construed as necessarily requiring their performance in the order discussed or illustrated, unless specifically identified as an order of performance. It is also to be understood that additional or alternative steps may be employed, unless otherwise indicated.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer, or section. Terms such as “first,” “second,” and other numerical terms when used herein do not imply a sequence or order unless clearly indicated by the context. Thus, a first step, element, component, region, layer, or section discussed below could be termed a second step, element, component, region, layer, or section without departing from the teachings of the example embodiments.

Throughout this disclosure, the numerical values represent approximate measures or limits to ranges and encompass minor deviations from the given values and embodiments, having about the value mentioned as well as those having exactly the value mentioned. Other than the working examples provided at the end of the detailed description, all numerical values of parameters (e.g., of quantities or conditions) in this specification are to be understood as being modified in all instances by the term “about” whether or not “about” actually appears before the numerical value. Numerical values of parameters in the appended claims are to be understood as being modified by the term “about” only when such term appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%. In addition, disclosure of ranges includes disclosure of all values and further divided ranges within the entire range, including endpoints and sub-ranges given for the ranges.

As used herein, the terms “composition” and “material” are used interchangeably to refer broadly to a substance containing at least the preferred chemical constituents, elements, or compounds, but which may also comprise additional elements, compounds, or substances, including trace amounts of impurities, unless otherwise indicated. An “X-based” composition or material broadly refers to compositions or materials in which “X” is the single largest constituent of the composition or material on a weight percentage (%) basis. This may include compositions or materials having, by weight, greater than 50% X, as well as those having, by weight, less than 50% X, so long as X is the single largest constituent of the composition or material based upon its overall weight. When a composition or material is referred to as being “substantially free” of a substance, the composition or material may comprise, by weight, less than 5%, optionally less than 3%, optionally less than 1%, or optionally less than 0.1% of the substance.

As used herein, the term “metal” may refer to a pure elemental metal or to an alloy of an elemental metal and one or more other metal or nonmetal elements (referred to as “alloying” elements). The alloying elements may be selected to impart certain desirable properties to the alloy that are not exhibited by the base metal element.

What is claimed is:

1. A method of manufacturing a composite structure for a battery that cycles lithium ions, the method comprising:
(a) depositing a positive electrode precursor on a substrate to form a positive electrode layer having a first end, an opposite second end, and a facing surface extending between the first end and the opposite second end, the positive electrode precursor comprising electroactive material particles, solid electrolyte particles, and electrically conductive particles;
(b) compacting the positive electrode layer on the substrate;
(c) depositing a solid electrolyte precursor on the substrate over the positive electrode layer to form a solid electrolyte layer having a major facing surface, the solid electrolyte precursor comprising solid electrolyte particles;
(d) compacting the solid electrolyte layer on the substrate over the positive electrode layer to form a composite structure including the positive electrode layer and the solid electrolyte layer; and
(e) heat treating the composite structure to sinter the solid electrolyte layer.

2. The method of claim 1, wherein the positive electrode precursor is prepared by mixing the electroactive material particles, the solid electrolyte particles, and the electrically conductive particles together in an extruder, and wherein the positive electrode precursor is deposited on the substrate via extrusion.

3. The method of claim 1, further comprising:
prior to step (c), applying a liquid electrolyte solution to the positive electrode layer to form a solid interphase layer on surfaces of the electroactive material particles.

4. The method of claim 1, wherein the solid electrolyte precursor is deposited on the substrate over the positive electrode layer via extrusion.

5. The method of claim 1, wherein the positive electrode layer is compacted in step (b) by applying a force of greater than or equal to about 100 megapascals to the facing surface of the positive electrode layer.

6. The method of claim 1, wherein the solid electrolyte layer is compacted in step (d) by applying a force of less than 100 megapascals to the major facing surface of the solid electrolyte layer.

7. The method of claim 1, wherein, prior to compacting the positive electrode layer and the solid electrolyte layer respectively in steps (b) and (d), the positive electrode layer and the solid electrolyte layer each have a porosity of greater than or equal to about 50% and less than or equal to about 70%, and wherein, after compacting the positive electrode layer and the solid electrolyte layer respectively in steps (b) and (d), the positive electrode layer and the solid electrolyte layer each have a porosity of greater than or equal to about 20% and less than or equal to about 45%.

8. The method of claim 1, wherein the solid electrolyte precursor is deposited on the substrate over the positive electrode layer such that the solid electrolyte layer extends over an entire facing surface of the positive electrode layer and along the first end and the opposite second end of the positive electrode layer such that the positive electrode layer is entirely encapsulated on the substrate by the solid electrolyte layer.

9. The method of claim 1, wherein, after step (e), the solid electrolyte layer has a thickness extending over the facing surface of the positive electrode layer of greater than or equal to about 1 micrometer and less than or equal to about 30 micrometers.

10. The method of claim 1, wherein the positive electrode precursor further comprises an organic solvent, and wherein, after the positive electrode precursor is deposited on the substrate, the organic solvent is removed therefrom to form the positive electrode layer.

11. The method of claim 1, wherein the solid electrolyte precursor further comprises an organic solvent, and wherein, after the solid electrolyte precursor is deposited on the substrate over the positive electrode layer, the organic solvent is removed therefrom to form the solid electrolyte layer.

12. The method of claim 1, wherein the composite structure is heat treated in step (e) at a temperature of greater than or equal to about 1000 degrees Celsius to sinter the solid electrolyte layer.

13. The method of claim 1, wherein the substrate comprises a release film, and wherein the method further comprises:
prior to step (e), removing the composite structure from the substrate and applying the composite structure to a major surface of a positive electrode current collector.

14. The method of claim 1, wherein the composite structure is manufactured using a continuous roll-to-roll process, and wherein the substrate comprises a web extending between a supply roll and a take-up roll.

15. The method of claim 14, wherein the positive electrode layer is compacted in step (b) by passing the positive electrode layer and the substrate between a first pair of calender rolls, and wherein the solid electrolyte layer is compacted in step (d) by passing the solid electrolyte layer and the substrate between a second pair of calender rolls.

16. The method of claim 1, wherein the positive electrode layer has a gradient structure, and wherein the method further comprises:
depositing a first positive electrode precursor on the substrate to form a first positive electrode layer; and then
depositing a second positive electrode precursor on the substrate over the first positive electrode layer to form a second positive electrode layer over the first positive electrode layer,
wherein the first positive electrode precursor and the second positive electrode precursor each comprise the electroactive material particles, the solid electrolyte particles, and the electrically conductive particles,
wherein a concentration of the solid electrolyte particles in the first positive electrode precursor is greater than that in the second positive electrode precursor, and
wherein a concentration of the electrically conductive particles in the second positive electrode precursor is greater than that in the first positive electrode precursor.

17. The method of claim 1, wherein the electroactive material particles comprise a lithium transition metal oxide, and wherein the solid electrolyte particles comprise an oxide-based solid electrolyte material, a sulfide-based solid electrolyte material, or a combination thereof.

18. A battery comprising a composite structure manufactured by the method of claim 1.

19. A method of manufacturing a composite structure for a battery that cycles lithium ions, the method comprising:
(a) depositing a positive electrode precursor on a substrate to form a positive electrode layer, the positive electrode precursor comprising electroactive material particles, solid electrolyte particles, and electrically conductive particles;
(b) depositing a solid electrolyte precursor on the substrate over the positive electrode layer to form a solid electrolyte layer over the positive electrode layer, the solid electrolyte precursor comprising solid electrolyte particles, the positive electrode precursor and the solid electrolyte precursor being deposited substantially simultaneously on the substrate by extrusion;
(c) compacting the positive electrode layer and the solid electrolyte layer on the substrate to form a composite structure comprising the positive electrode layer and the solid electrolyte layer;
(d) transferring the composite structure from the substrate to a positive electrode current collector; and
(e) heat treating the composite structure on the positive electrode current collector to sinter the solid electrolyte layer.

20. The method of claim 19, wherein the solid electrolyte precursor is deposited on the substrate over the positive electrode layer such that the positive electrode layer is entirely encapsulated on the substrate by the solid electrolyte layer.
